(19) United States
(12) Patent Application Publication
(10) Pub. No.: US 2007/0202976 A1
(43) Pub. Date: Aug. 30, 2007

(54) Power regeneration system with electromagnetic variable speed control

(76) Inventor: Daren Luedtke, Mansfield, MO (US)

Correspondence Address: THE SMALL PATENT LAW GROUP LLP, 611 OLIVE STREET, SUITE1611, ST. LOUIS, MO, 63101, US

(21) Appl. No.: 11/789,082

(22) Filed: Apr. 23, 2007

Related U.S. Application Data
(63) Continuation-in-part of application No. 11/584,139, filed on Oct. 17, 2006.
(60) Provisional application No. 60/727,958, filed on Oct. 18, 2005.

(51) Int. Cl. F16H 61/00; F16H 9/00; F16H 63/00

(52) U.S. Cl. 474/70; 474/69

(57) ABSTRACT

A power regeneration system is provided. A variable speed drive system is also provided that includes a drive shaft and a variable speed electromagnetic control connected to the drive shaft. At least one of the power regeneration system and a drive motor system are connected to the drive shaft.

### CROSS REFERENCE TO RELATED APPLICATIONS

This application is a continuation-in-part of and claims priority to copending non-provisional U.S. patent application entitled “POWER REGENERATION SYSTEM,” assigned Ser. No. 11/584,139, and filed Oct. 17, 2006, which claims priority to and the benefit of the filing date of U.S. Provisional Application No. 60/727,958, filed on Oct. 18, 2005, entitled “Regeneratively Charged Electric Vehicle,” which are hereby incorporated by reference in their entirety.

### BACKGROUND OF THE INVENTION

This invention relates generally to power recharging systems, and more particularly, to regenerative power charging systems for electric vehicles (EVs).

EVs typically include one or more rechargeable power supplies, for example, battery packs, for storage of electric power. The stored electric power may be used to power a drive motor to propel the vehicle and several electronic elements used to control the vehicles performance and safety while being driven. For example, known EVs typically include a motor controller that not only provides the amperage required by the motor to move the vehicle (e.g., power from the battery pack to the motor), but also monitors the flow of that power and other aspects of motor performance, such as the ohms reading from a potentiometer. If a reading is out of a predetermined and/or preprogrammed value range, then for example, the logic portion of the motor controller shuts off the power portion of the motor controller, thereby turning off the power to the motor and bringing the vehicle to rest until the condition (e.g., performance abnormality) is corrected. Once the condition is corrected the motor controller resumes normal operating power functions, for example, according to the drivers input with a potentiometer that usually operates in conjunction with the foot feed, commonly referred to as the “gas pedal” of the vehicle.

Additionally, when “regenerative braking” is incorporated in an EV, either the motor acts as a regenerative source of power upon deceleration, which typically supplies less than twenty five percent of the used battery amperage back to the battery pack during deceleration once the brake pedal is applied, or an additional alternator or generator and regulator are incorporated in the system, supplying even less battery amperage back to the battery pack than the motor during regeneration and deceleration. With only twenty five percent regeneration of the amperage draw during brake application occurring during deceleration and deceleration occurring only a very small percentage of the time the vehicle is traveling, the amount of regeneration is even smaller resulting in a very small and inefficient recharge verses amperage draw ratio with the conventional EV. Thus, an EV has a substantially lower amount of available travel distance compared to a vehicle using an internal combustion engine and a supply of gasoline or diesel. For example, a typical gasoline powered automobile can travel three to four hundred miles on a tank of fuel and takes about five minutes to refuel. The average EV only travels about one hundred miles per battery charge and typically takes six to eight hours to recharge even with “regenerative braking” added to the EVs system. This limited travel distance per charge and length of recharge time has resulted in the unpopularity and lack of demand for EVs.

### BRIEF DESCRIPTION OF THE INVENTION

In one embodiment, a variable speed drive system is provided that includes a drive shaft and a variable speed electromagnetic control connected to the drive shaft. The variable speed drive system further includes at least one of a regeneration system and a drive motor system connected to the drive shaft.

In another embodiment, a vehicle is provided that includes a rechargeable power supply, a regeneration system connected to the rechargeable power supply and a drive shaft connected to the regeneration system. The vehicle further includes a variable speed electromagnetic control connected to the drive shaft.

In yet another embodiment, a method for controlling a variable speed drive is provided. The method includes varying the speed of a vehicle drive using a variable speed electromagnetic control.

### BRIEF DESCRIPTION OF THE DRAWINGS

FIG. 1 is a block diagram of power regeneration system for a motive application constructed in accordance with an embodiment of the invention.

FIG. 2 is a top plan view of a momentum regenerative charging system constructed in accordance with an embodiment of the invention.

FIG. 3 is a side plan view of a momentum regenerative charging system constructed in accordance with an embodiment of the invention.

FIG. 4 is a front plan view of a momentum regenerative charging system constructed in accordance with an embodiment of the invention.

FIG. 5 is a side plan view of a wind regenerative charging system constructed in accordance with an embodiment of the invention.

FIG. 6 is a front plan view of a wind regenerative charging system constructed in accordance with an embodiment of the invention.

FIG. 7 is a flowchart of a method for regenerative charging in accordance with an embodiment of the invention.

FIG. 8 is a block diagram of a wiring system for a momentum regenerative charging system constructed in accordance with an embodiment of the invention in connection with a variable speed drive system.

FIG. 9 is a block diagram of a wiring system for a wind regenerative charging system constructed in accordance with an embodiment of the invention.

FIG. 10 is a block diagram of a power regeneration system constructed in accordance with an embodiment of the invention connected to a variable speed electromagnetic control in one exemplary configuration.

FIG. 11 is a block diagram of a power regeneration system constructed in accordance with an embodiment of the invention connected to a variable speed electromagnetic control in another exemplary configuration.

FIG. 12 is a block diagram of a power regeneration system constructed in accordance with an embodiment of the invention connected to a variable speed electromagnetic control in another exemplary configuration.

FIG. 13 is a block diagram of a power regeneration system constructed in accordance with an embodiment of the invention connected to a variable speed pulley transmission.

### DETAILED DESCRIPTION OF THE INVENTION

As used herein, an element or step recited in the singular and proceeded with the word “a” or “an” should be understood as not excluding plural elements or steps, unless such exclusion is explicitly recited. Furthermore, references to “one embodiment” and “an embodiment” of the present invention are not intended to be interpreted as excluding the existence of additional embodiments that also incorporate the recited features.

Various embodiments of the invention provide a momentum regenerative charging system. The momentum regenerative charging system includes electrical and mechanical components that utilize the momentum of the vehicle to recharge one or more battery packs. Optionally and/or additionally, a regenerative wind charging system may be provided that includes electrical and mechanical components that generate additional power to charge the one or more battery packs using the power of the wind. A variable speed electromagnetic control also may be provided.

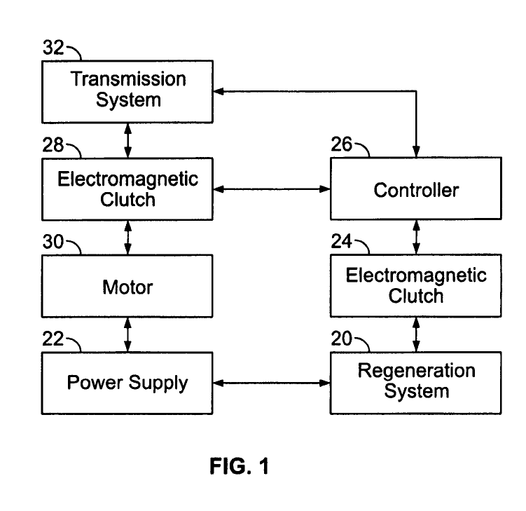

As shown in FIG. 1, a regenerative charging system, and more particularly a momentum regeneration system 20 is connected to a power supply 22 that may include one or more battery packs. The momentum regeneration system 20 is also connected to an electromagnetic clutch 24 configured to selectively engage and disengage the momentum regeneration system 20 as described in more detail herein. A controller 26 (e.g., a drive system controller) is connected to the electromagnetic clutch 24 and to an electromagnetic clutch 28 configured to selectively engage and disengage a motor 30 from a transmission system 32. The transmission system 32 may be a variable speed drive system having a plurality of variable speed drive pulleys as described in co-pending U.S. patent application having attorney docket number SPLG 11750-1 and entitled “Variable Speed Transmission,” the entire disclosure of which is hereby incorporated by reference herein.

The power supply 22 may be configured in different arrangements to provide power to one or more systems or components. For example, in an automobile application, a standard twelve volt battery may be used to power accessories in the automobile, such as, lights, wipers, horn, etc. A separate low voltage (e.g., twelve volt) battery pack may be provided to power non-motor components, such as, the electromagnetic clutches 24 and 28, relays, processors, a stepper motor, etc. A high voltage (e.g., ninety-six volt) battery pack also may be provided to separately power the motor 30. It should be noted that the twelve volt batteries may be combined as a single battery. The voltage and amperage of the battery packs may be provided as needed with a plurality of individual batteries (e.g., 6 volts batteries) wired in series, series/parallel combinations, or parallel.

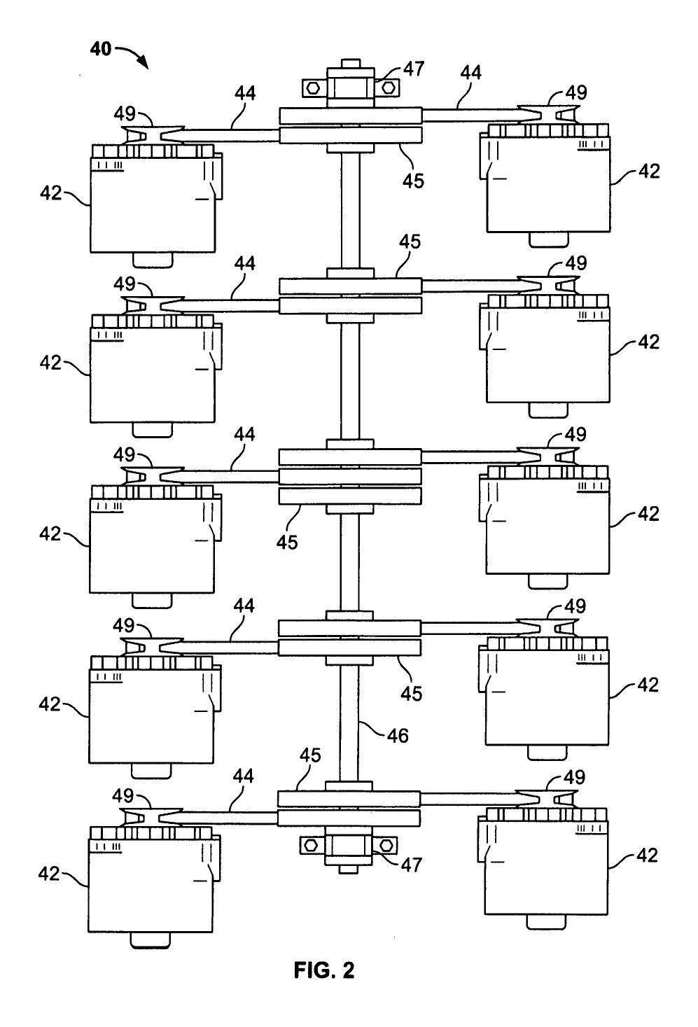

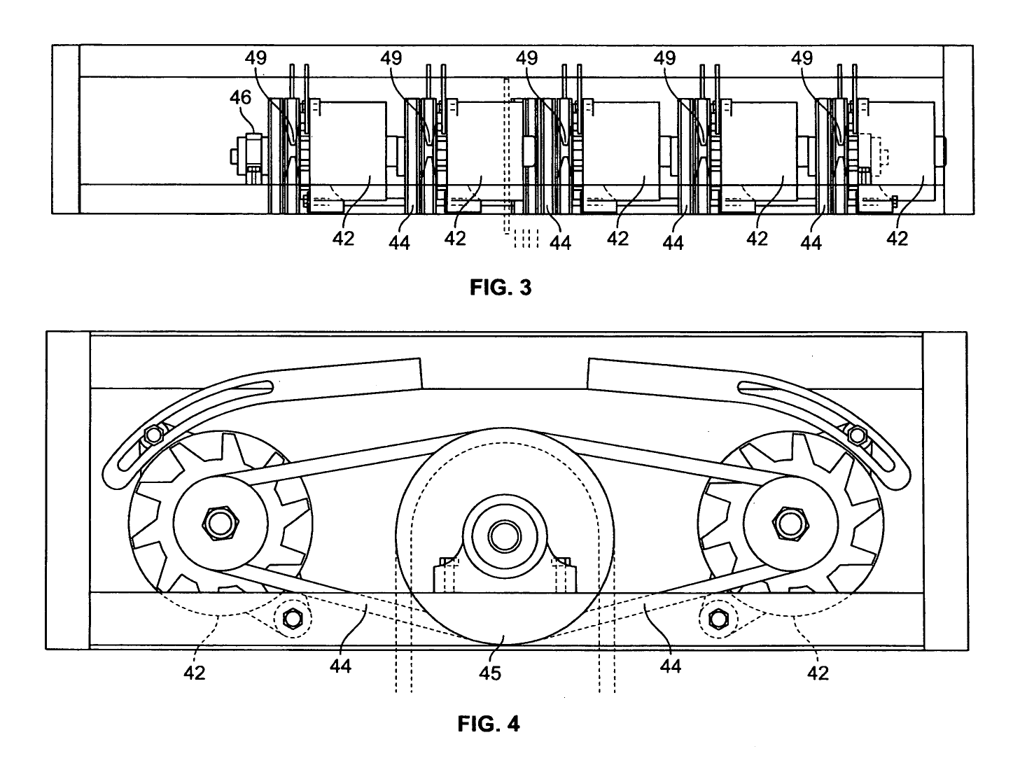

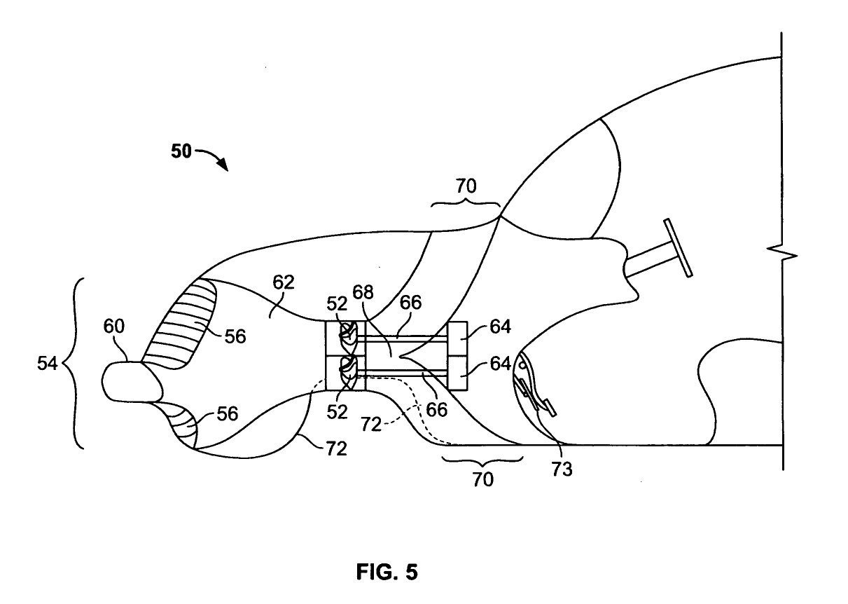

Various embodiments of the invention provide a momentum regeneration system 20 including a momentum regenerative charging system 40 as shown in FIGS. 2 through 4. The momentum regenerative charging system 40 includes a plurality of alternators 42 (or generators) connected by belts 44 to a plurality of pulleys 45 mounted on a center shaft 46. More particularly, the shaft 46 is adaptably mounted to a framework, for example, within a vehicle, using bearing mounts 47 such as carrier bearings with the plurality of alternators 42 also mounted to the framework so as to be compatibly coupled with the belts 44 from alternator pulleys 49 to the pulleys 45 on the shaft 46. An additional pulley (not shown) is provided and compatibly coupled with a belt (not shown) to a pulley on the electromagnetic clutch 24 (shown in FIG. 1), which may be located on a drive shaft of a pulley (e.g., variable speed pulley) of the transmission system 32 closest to the motor 30 (shown in FIG. 1).

Each alternator 42 is connectively wired to one or more batteries in the power supply 22 (shown in FIG. 1), for example, to both the high voltage battery packs and low voltage battery packs, to produce a connection of equal nominal voltages between each battery or set of batteries of the battery packs and the rated nominal voltage of each alternator 42.

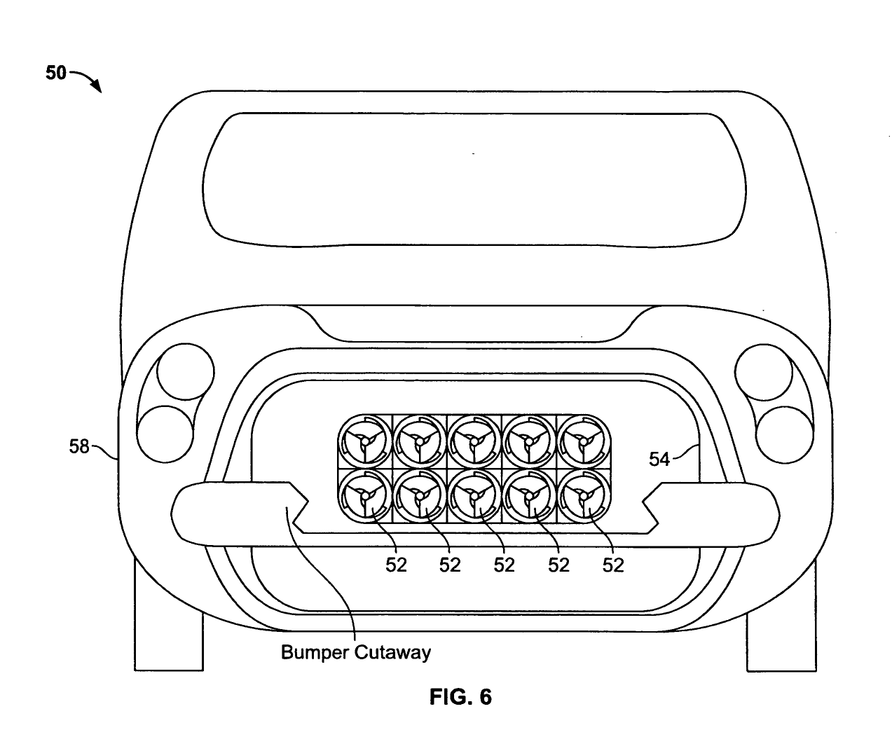

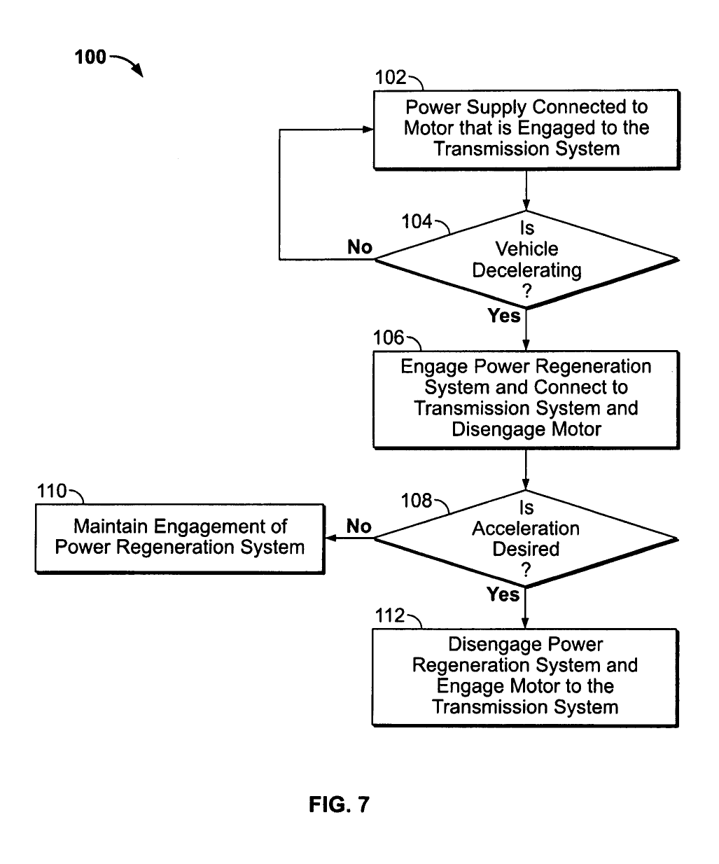

Optionally and/or additionally, a wind regenerative charging system 50 for power regeneration also may be provided as shown in FIGS. 5 and 6. The wind regenerative charging system 50 is illustrated in a vehicle application, but it should be appreciated that the wind regenerative charging system 50 may be used in connection with any type of motive application, for example, a train, airplane, tractor, forklift, golf cart, wheelchair, etc. The wind regenerative charging system 50 includes a plurality of wind turbines 52 positioned at the air intake openings 54 in the grill areas 56 of a vehicle 58 (e.g., electric vehicle). The grill areas 56 are typically located above a bumper 60 with an air intake chamber 62 behind the grill areas 56. The wind turbines 52 are connected to generators 64 via turbine shafts 66 that are located in an exhaust air chamber 68 extending out of the vehicle 58 through exhaust openings 70. It should be noted that the wind turbines 52 may be positioned generally above wheel wells 72 of the vehicle 58.

In operation in a motive application (e.g., in a vehicle), when the momentum regenerative charging system 40 is engaged, which occurs in a motive application each time the vehicle decelerates as described below, the momentum regenerative charging system 40 provides power to charge, for example, the power supply 22, including the both the high voltage and the low voltage battery packs. The momentum regenerative charging system 40 for power regeneration is activated, and in particular, engaged by the electromagnetic clutch 24 as controlled by the controller 26, during a majority of periods of deceleration without, for example, having to apply the brake pedal in the vehicle. The wind regenerative charging system 50 is activated upon activation of the ignition of the vehicle 58 (e.g., when the ignition key is inserted and turned).

More particularly, and referring to FIG. 1, the electromagnetic clutch 24 that is adaptably coupled to the transmission system 32 engages and disengages the momentum recharging alternators 42 or generators 64 from the mechanical system of the transmission system 32 (e.g., from the variable speed pulleys or transmission shaft). Accordingly, when the vehicle 58 is accelerating or cruising at any given rate of speed the electromagnetic clutch 28, namely the drive motor electromagnetic clutch 28 is engaged to the transmission system 32 propelling the vehicle. It should be noted that the generators 64 also may be engaged if a minimum predetermined speed is reached. However, when deceleration occurs beyond a preset or predetermined limit, the controller 26, which may be a programmable logic computer (PLC), disengages the electromagnetic clutch 28 and engages the electromagnetic clutch 24, namely the momentum recharging electromagnetic clutch 24. This operation causes rotation of the shaft 46 that is now engaged with the transmission system 32 (which may be provided via one or more reduction pulleys) and accordingly causes the rotation of the alternators 42, thereby providing regenerative amperage back into both the high voltage and low voltage battery packs during deceleration.

Specifically, once the electromagnetic clutch 24 is engaged thereby rotating the pulley of the electromagnetic clutch 24, the rotation is transferred through a belt to the shaft 46, with the shaft 46 rotating the adaptably mounted pulleys 45. The rotation of the pulleys 45 in turn is transferred through the belts 44 to the plurality of alternators 42, thereby rotating the alternators 42 and generating power that is provided through wiring into batteries of the battery packs within the power supply 22. This rotating operation creates additional stored power (e.g., amperage) capable of transporting the vehicle 58, for example, for an extended period of time and for greater distances. Thus, the regeneration system 20 harnesses the momentum of, for example, an electric vehicle and converts that momentum into regenerative electrical power.

It should be noted that with the electromagnetic clutch 24 adaptably coupled to, for example, the pulley in the transmission system 32 that is closest to the motor 30, the rate of motion remains relatively the same, generating relatively the same amount of power even as the vehicle 58 decreases in speed.

It further should be noted that the engagement of the momentum regenerative charging system 40 by the electromagnetic clutch 24 occurs with or without applying the brake pedal 73 (shown on FIG. 5) of the vehicle 58 (shown in FIG. 6), even if deceleration is only occurring, for example, during the time that a vehicle in front of the vehicle 58 is turning into a driveway, or while coasting down a long downhill grade. Thus, the rate of regeneration of power to the battery storage systems of, for example, an electric vehicle is increased (compared to that of conventional “regenerative braking” systems currently incorporated in EVs).

Further, in operation, particularly at higher speeds, the wind regenerative charging system 50 is configured to harness the power of wind resistance created with movement of an object, for example, the vehicle 58. More particularly, the basic equation for energy production through wind generation is: P=ρAV³, where “P” is power in Joules, “p” is the density of the air, “A” is the area of the propeller that faces the oncoming wind, and “V” is the wind speed in meters per second. The most important term of this relationship is the wind speed “V”. This equation shows that the power in Joules is proportional to the cube of the value of wind speed. This indicates that the power that can be produced from the wind is exponentially larger than the wind speed. For example, if the speed of the wind is two meters per second, the wind power available is eight joules. Accordingly, instead of sealing off the front (usually engine) compartment of the vehicle 58 as is customary in EVs, the opening usually provided for the radiator air flow in internal combustion vehicles is utilized to generate secondary power regeneration, during movement of the vehicle, and particularly at higher speeds, such as during highway travel, where deceleration does not occur as often as during city driving.

The wind regenerative charging system 50 essentially forms multiple wind tunnels. As the speed of the vehicle 58 increases, the air flow through the wind tunnels increases thereby increasing the amount of power generated by the generators 64 connected to the wind turbines 52. This power generation can multiply exponentially so as to provide exponentially more power to the battery packs during the time that the deceleration rate is exponentially lower.

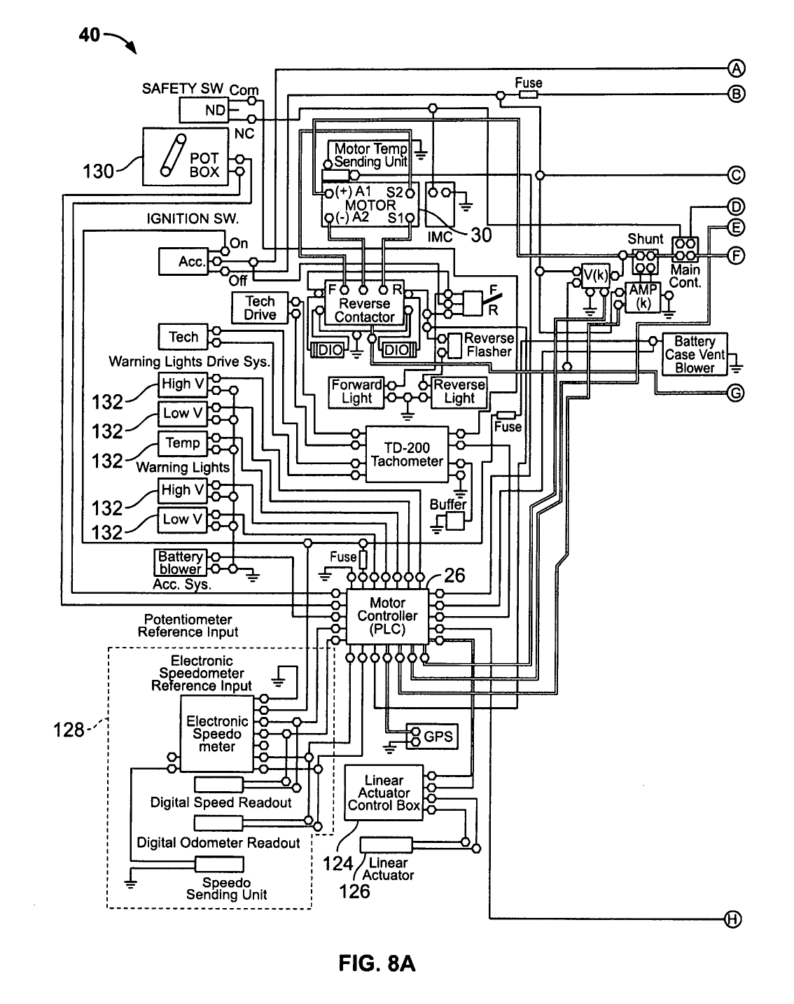

Accordingly, various embodiments of the invention provide power regeneration in motive applications. More particularly, as shown in FIG. 7, a method 100 for regeneratively charging one or more battery packs, for example, in a vehicle such as an EV, includes at 102 providing power supply to a motor (e.g., connecting a power supply having a plurality of battery packs to a motor) that is engaged to a transmission system to move the vehicle. This power supply is provided when the vehicle is accelerating or maintained at a constant speed, such as coasting and may be determined based on pressure applied to a foot feed (e.g., gas pedal) in the vehicle. For example, a potentiometer may be used to determine a resistance value (e.g., ohm reading) based on depression of the foot feed. A determination is then made at 104 as to whether the vehicle is decelerating, namely, whether there is a deceleration condition. If the vehicle is not decelerating, then the power supply remains connected to the motor 102. However, if the vehicle is decelerating, then at 106, a power regeneration system is engaged (to recharge one or more battery packs) and connected to the transmission system with the motor disengaged from the transmission system. The determination of whether the vehicle is decelerating may be based on an ohm reading of the foot feed decreasing below a predetermined limit indicating that a user is reducing speed or removing his or her foot from the foot pedal. Alternatively, or in addition, a similar determination may be made as to whether the user is applying pressure to the brake pedal based on an ohm reading. If a determination is made that either the gas pedal is being released (and cruise control is not activated) or the brake pedal is being depressed, the power regeneration system is engaged and the motor disengaged from the transmission system. The control of the switching may be controlled by a controller, such as a PLC.

Thereafter, a determination is made at 108 as to whether acceleration is desired. If acceleration is not desired, for example, if the vehicle continues to decelerates, then the engagement of the power regeneration system is maintained at 110. However, if a determination is made at 108 that acceleration is desired, then at 112, the power regeneration system is disengaged and the motor reengaged with the transmission system. The determination of whether acceleration is desired may be based on, for example, detecting that the gas pedal is being depressed.

It should be noted that a wind regenerative charging system also may be provided to charge one or more battery packs in the vehicle as described herein.

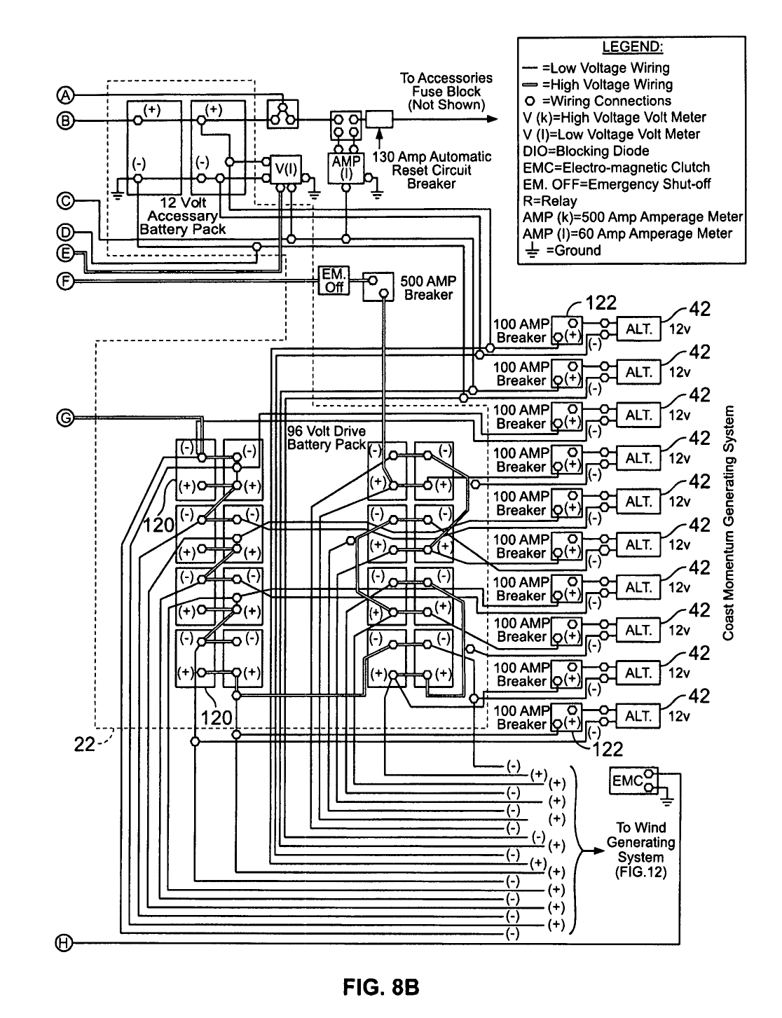

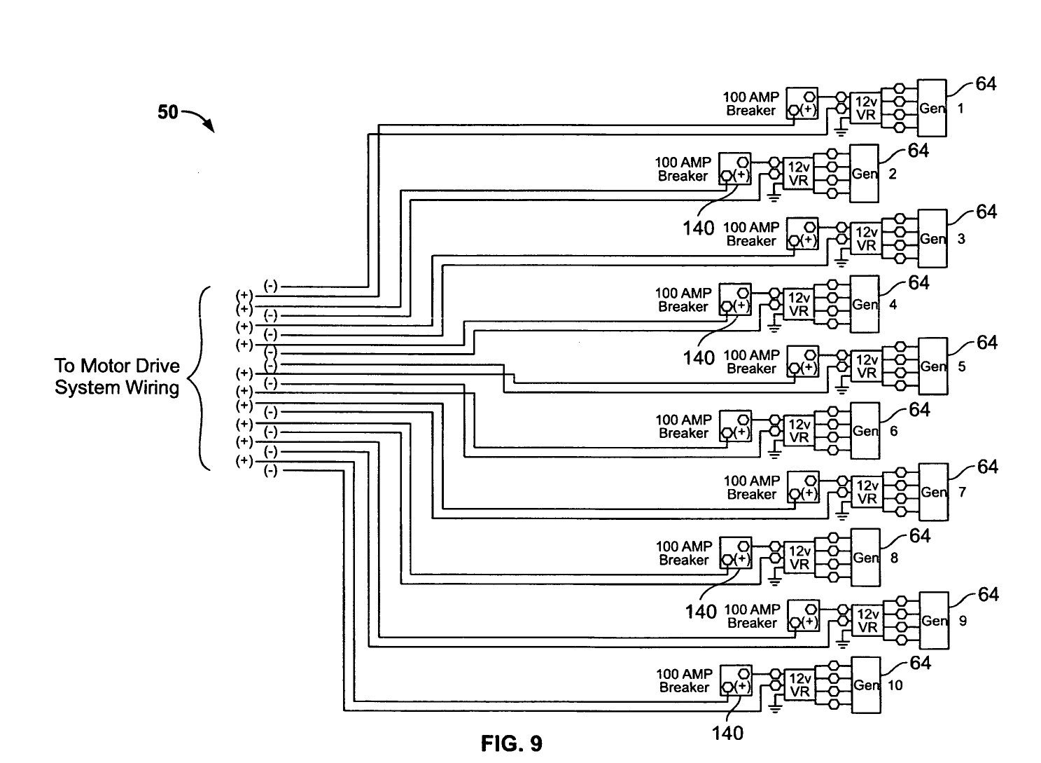

The momentum regenerative charging system 40 and the wind regenerative charging system 50 may be provided in different configurations. One configuration for the momentum regenerative charging system 40 is shown in FIG. 8 in connection with a variable speed drive transmission. As shown, the power supply 22 may include one or more battery packs 120 connected to the plurality of alternators 42 through breakers 122. Control mechanisms for controlling and activating the transmission system also may be provided such as a linear actuator controller 124 controlling a linear actuator 126. Additional measuring components 128 may be provided to determine the speed of the vehicle and a potentiometer 130 may be included to determine different conditions, such as acceleration or deceleration of the vehicle as described herein. A plurality of warning and indicator lights 132 also may be provided, such as, for temperature levels, voltage levels, etc. The battery packs 120 also may be connected to the wind regenerative charging system 50 shown in FIG. 9. The battery packs 120 are connected to the generators 64 through breakers 14.

While particular embodiments of the invention have been shown and described, it will be apparent to those skilled in the art that changes and modifications may be made without departing from the various embodiments of the invention. For example, the number of alternator or generators may be increased or decreased based on the power requirements for the application. The number and power output of the battery packs also may be increased or decreased based on the power requirements for the application. Further, the various embodiments may be implemented in connection with any motive application and are not limited to electric vehicles. For example, in addition to cars, buses, golf carts, urban commuter vehicles, etc., the various embodiments may be implemented in connection with lawn mowers, wheelchairs, etc.

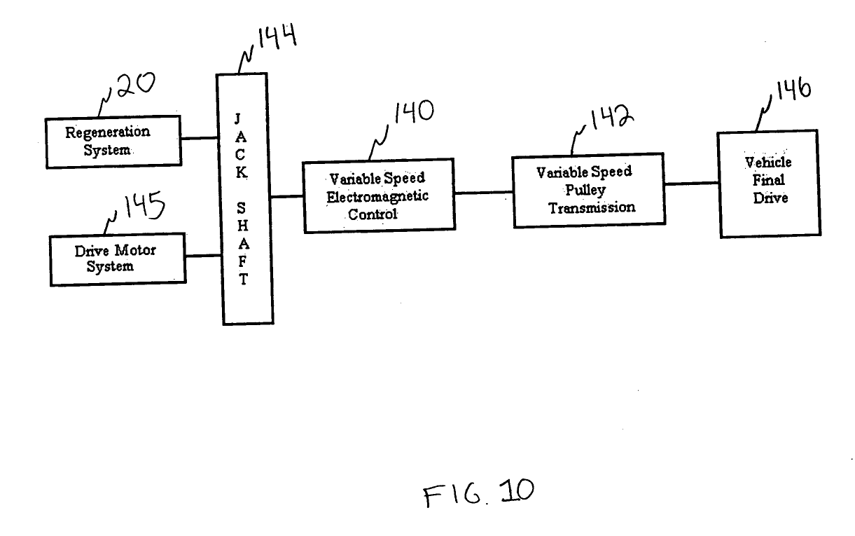

As a further example, various embodiments of the invention may include a variable speed electromagnetic control 140 as shown in FIGS. 10 through 12. The variable speed electromagnetic control 140 may be any magnetically coupled control that is frequency independent, for example, operates independently from the speed of a motor. For example, the variable speed electromagnetic control 140 may be a magnetic-coupled variable speed belt drive available from Coyote Electronics of Fort Worth, Tex.

The variable speed electromagnetic control 140 may be provided between a variable speed pulley transmission 142 and a shaft 144 (e.g., a jack shaft or drive shaft). The variable speed pulley transmission 142 may be implemented or configured as the transmission system 32 (shown in FIG. 1) and as described in more detail herein. Further, the shaft 144 may be the center shaft 46 (shown in FIG. 2). The shaft 144 is connected to at least one of the regeneration system 20 and a drive motor system 145, which may include the motor 30 (shown in FIG. 1). Additionally, the variable speed pulley transmission 142 is provided between the variable speed electromagnetic control 140 and a final drive component 146 (e.g., final vehicle drive connected to an axle of a vehicle). The variable speed pulley transmission 142 acts or operates as a “clutch mechanism” to smooth the initial starting and stopping of, for example, a vehicle.

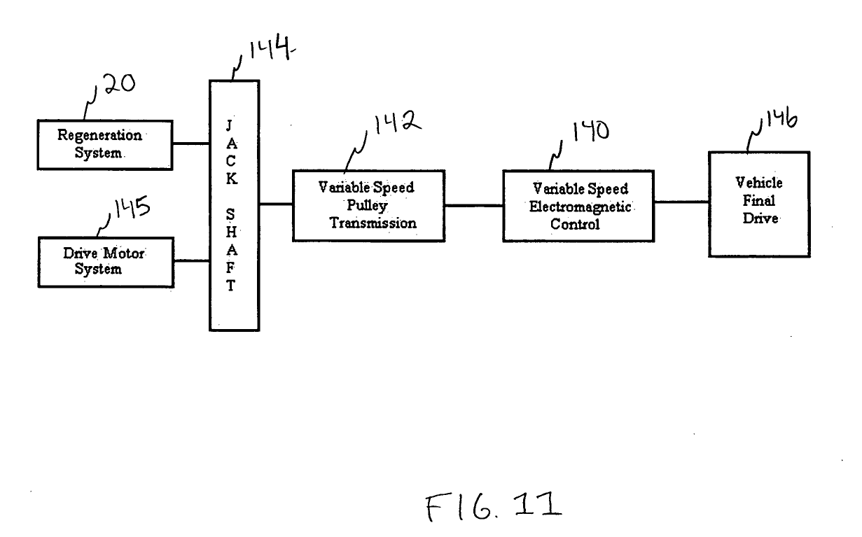

In another embodiment, as shown in FIG. 11, the variable speed pulley transmission 142 is provided between the shaft 144 and the variable speed electromagnetic control 140. In this embodiment, the variable speed electromagnetic control 140 is provided between the variable speed pulley transmission 142 and the final drive component 146.

In operation, the variable speed electromagnetic control 140 in the embodiments shown in FIGS. 10 and 11 operates to control the variable speed pulley transmission 142 independent of the operating speed of the drive motor system 145. For example, in a motive application such as in a vehicle, when a driver of the vehicle depresses the accelerator pedal, the motor 30 (shown in FIG. 1) is turned on and runs at a predetermined speed, for example, at a maximum or fullest speed, which may be determined by the amount of torque needed to move the vehicle from a stopped condition. The variable speed electromagnetic control 140 is then provided or fed an amount of electric power proportional to the amount of linear actuator movement of the variable speed pulley transmission 142, thereby engaging the electromagnetic control 140 proportionally, providing a smoother start to vehicle movement similar to engaging a mechanical clutch, rather than engaging the motor 30 and variable speed pulley transmission 142 without the variable speed electromagnetic control.

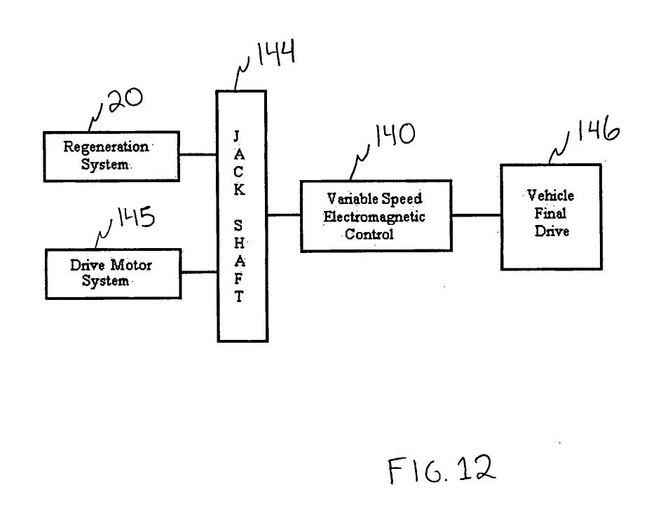

In yet another embodiment, as shown in FIG. 12, the variable speed pulley transmission 142 is removed with the variable speed electromagnetic control 140 provided between the shaft 144 and the final drive component 146. In this embodiment, the variable speed electromagnetic control 140 provides variable speed drive operation that otherwise would be provided by the variable speed pulley transmission 142. The variable speed drive operation is again independent of the operating speed of the drive motor system 144 as described in above in connection with embodiments illustrated in FIGS. 10 and 11.

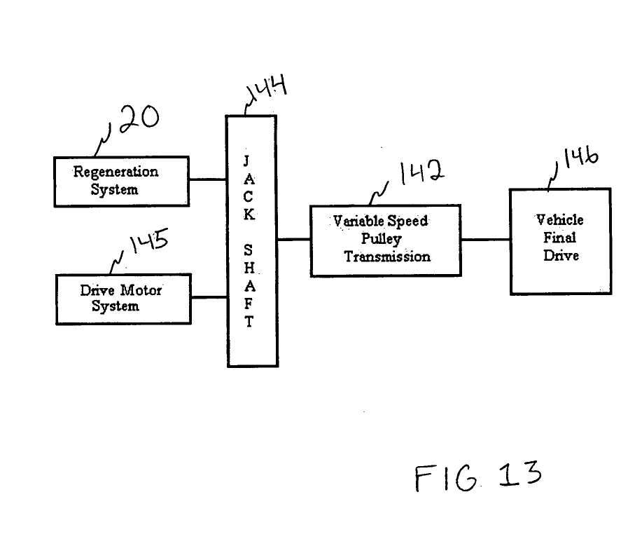

It should be noted that the variable speed electromagnetic control 140 also may be removed, as shown in FIG. 13, with the variable speed pulley transmission 142 provided between the shaft 142 and the final drive component 146. In this embodiment, operation may be provided as described in co-pending U.S. patent application entitled “Variable Speed Transmission” identified above.

Thus, a momentum regenerative charging system is provided that utilizes the momentum of the vehicle to recharge the battery packs upon deceleration of the vehicle. Further, an additional regenerative wind charging system also may be provided that generates additional power to the battery packs by harnessing the power of the wind, particularly at higher vehicle speeds. A variable speed electromagnetic control is also provided that operates independent of a drive motor system speed.

While the invention has been described in terms of various specific embodiments, those skilled in the art will recognize that the various embodiments of the invention can be practiced with modification within the spirit and scope of the claims.

What is claimed is:

1. A variable speed drive system comprising:
a drive shaft;
a variable speed electromagnetic control connected to the drive shaft; and
at least one of a regeneration system and a drive motor system connected to the drive shaft.

2. A variable speed drive system in accordance with claim 1 further comprising a variable speed pulley transmission with the variable speed electromagnetic control between the variable speed pulley transmission and the drive shaft.

3. A variable speed drive system in accordance with claim 2 further comprising a final drive component and wherein the variable speed pulley transmission is between the variable speed electromagnetic control and the final drive component.

4. A variable speed drive system in accordance with claim 3 wherein the final drive component comprises a vehicle drive.

5. A variable speed drive system in accordance with claim 1 further comprising a variable speed pulley transmission with the variable speed pulley transmission between the variable speed electromagnetic control and the drive shaft.

6. A variable speed drive system in accordance with claim 5 further comprising a final drive component and wherein the variable speed electromagnetic control is between the variable speed pulley transmission and the final drive component.

7. A variable speed drive system in accordance with claim 6 wherein the final drive component comprises a vehicle drive.

8. A variable speed drive system in accordance with claim 1 wherein the variable speed electromagnetic control is magnetically coupled to a variable speed belt drive.

9. A variable speed drive system in accordance with claim 1 wherein the variable speed electromagnetic control is mechanically coupled to a drive motor via a jack shaft.

10. A variable speed drive system in accordance with claim 1 further comprising a drive system controller and wherein the variable speed electromagnetic control is electrically coupled to the drive system controller.

11. A variable speed drive system in accordance with claim 11 further comprising a variable speed belt drive and wherein the variable speed electromagnetic control is magnetically coupled to a variable speed belt drive.

12. A variable speed drive system in accordance with claim 1 wherein both of the regeneration system and the drive motor system are connected to the drive shaft.

13. A variable speed drive system in accordance with claim 1 wherein the variable speed electromagnetic control is frequency independent.

14. A variable speed drive system in accordance with claim 1 wherein the regeneration system comprises a regenerative charging system having a plurality of battery packs.

15. A variable speed drive system in accordance with claim 1 wherein the drive motor system comprises a motor with an operating speed of the motor independent of the operating speed of the variable speed electromagnetic control.

16. A variable speed drive system in accordance with claim 1 wherein the variable speed electromagnetic control is a variable speed transmission system for a vehicle.

17. A variable speed drive system in accordance with claim 16 wherein the vehicle comprises one of an electric vehicle, an internal combustion engine powered vehicle, a hybrid vehicle and a combination thereof.

18. A variable speed drive system in accordance with claim 1 further comprising a plurality of battery packs connected to the regeneration system and to a wind power system.

19. A vehicle comprising:
a rechargeable power supply;
a regeneration system connected to the rechargeable power supply;
a drive shaft connected to the regeneration system; and
a variable speed electromagnetic control connected to the drive shaft.

20. A vehicle in accordance with claim 19 further comprising a drive motor system connected to the drive shaft.

21. A vehicle in accordance with claim 19 further comprising a variable speed pulley transmission connected to the variable speed electromagnetic control.

22. A method for controlling a vehicle drive, the method comprising:
varying the speed of a vehicle drive using a variable speed electromagnetic control.

23. A method in accordance with claim 22 further comprising coupling a regeneration system and a drive motor system to the variable speed electromagnetic control via a drive shaft.
